(19) United States
(12) Patent Application Publication
(10) Pub. No.: US 2022/0329434 A1
(43) Pub. Date: Oct. 13, 2022

(54) COMMUNICATIONS DEVICE AND/OR AUTHENTICATION SERVER USING SUBSCRIBER BIOMETRIC ATTRIBUTES

(71) Applicant: Payfone, Inc., New York, NY (US)

(72) Inventor: Jeffrey Robert Naujok, Colorado Springs, CO (US)

(21) Appl. No.: 17/225,964

(22) Filed: Apr. 8, 2021

(51) Int. Cl. H04L 9/32; H04W 12/06; H04W 12/37; H04W 12/65

(52) U.S. Cl. CPC H04L 9/3231; H04W 12/06; H04W 12/37; H04W 12/65; H04L 9/3239

(57) ABSTRACT

Briefly, methods, apparatuses, and/or articles of manufacture may be implemented to authenticate a subscriber of a communications device. The method may include receiving, such as at an authenticating server via a client server, an indication that a subscriber is attempting to access secure content via the communications device. The method may continue with transmitting one or more anonymizing parameters from the authentication server to the communications device. The method may continue with receiving, by the authentication server, in response to transmitting the one or more anonymizing parameters to the communications device, first one or more anonymized values computed using the one or more anonymizing parameters and one or more biometric attributes of the subscriber. The method may continue with authenticating the subscriber based, at least in part, on comparing the received one or more anonymized values with the one or more anonymized values computed at the authentication server.

### BACKGROUND

### 1. Field

The present disclosure relates generally to obtaining authorization to perform electronic transactions, such as facilitated by an electronic communications device, which may involve authenticating an individual operating, or at least co-located with, a particular communications device.

### 2. Information

The World Wide Web or simply the Web, as enabled by Internet computing, routing, and/or wireless transmission resources, has grown rapidly in recent years at least partially in response to the relative ease by which a wide variety of transactions can be performed or enabled via the Internet. As a consequence of widely available Internet connections, including connections to the Internet facilitated by mobile cellular communication services, for example, a mobile subscriber may shop and/or browse for virtually any product and/or service utilizing a handheld communications device. However, in such an environment, in which electronic, Internet-based commerce has become increasingly common, occurrences of fraud and deception, unfortunately, can also occur. To reduce the instances of fraud and deception, fraud-detection and prevention processes may be implemented. Such implementations may be utilized, for example, in connection with numerous types of online or electronic transactions, which may include financial transactions, establishment of lines of credit, in-store purchases for goods and/or services, access to privileged entertainment content, and so forth.

As communications devices typically utilized for performing Internet-based electronic transactions, such as smart phones, tablet computing devices, laptop computers, etc., become increasingly sophisticated, techniques for utilizing such devices to commit fraud have also become more sophisticated. Such techniques may involve use and/or knowledge of complex technology, for example, which may be related to the particular hardware and/or software platforms associated with such communications devices. Accordingly, reduction in the instances of fraud and deception, which may involve, for example, use of various electronic devices, continues to be an active area of investigation.

### SUMMARY

One general aspect includes a method of authenticating a subscriber co-located with a communications device, which includes receiving, at an authentication server via a client server, an indication of the subscriber attempting to access secure content via the communications device. The method additionally includes transmitting one or more anonymizing parameters from the authentication server to the communications device and receiving, by the authentication server, first one or more anonymized values computed by the communications device based, at least in part, on the one or more anonymizing parameters transmitted to the communications device and one or more biometric attributes of the subscriber accessible to the communications device. The method also includes computing, by the authentication server, second one or more anonymized values based, at least in part, on the one or more anonymizing parameters transmitted to the communications device. The method also includes authenticating the subscriber based, at least in part, on a comparison between the first one or more anonymized values and the second one or more anonymized values.

In particular embodiments, the method may further include obtaining the one or more anonymizing parameters and one or more biometric attributes of the subscriber prior to authenticating the subscriber. In particular embodiments, the method may further include permitting the subscriber to access the secure content responsive to authenticating the subscriber. In particular embodiments, the first and second one or more anonymized values are computed utilizing a one-way function that accepts signals representing the one or more biometric attributes of the subscriber and the one or more anonymizing parameters. In particular embodiments, the one-way function corresponds to a hash function. In particular embodiments, the attempt to access the secure content corresponds to a login attempt by the subscriber via the communications device. In particular embodiments, the communications device corresponds to a mobile communications device. In particular embodiments, the one or more biometric attributes of the subscriber correspond to attributes collected while the subscriber is in possession of, or at least co-located with, the communications device. In particular embodiments, the one or more biometric attributes of the subscriber correspond to biometric attributes of the subscriber collected while the subscriber is operating the communications device. In particular embodiments, the one or more biometric attributes of the subscriber correspond to passively-collected attributes.

Another general aspect includes an apparatus having a processor coupled to at least one memory device to receive an indication in response to a subscriber attempting to access secure content via a communications device. The processor coupled to the at least one memory device are also to anonymize one or more signal outputs of the communications device. The processor coupled to the at least one memory device are also to receive first one or more anonymized values computed by the communications device based, at least in part, on the one or more anonymizing parameters transmitted to the communications device and one or more biometric attributes of the subscriber accessible to the communications device. The processor coupled to the at least one memory device are also to compute second one or more anonymized values based, at least in part, on the one or more anonymizing parameters transmitted to the communications device. The processor coupled to the at least one memory device are also to authenticate the subscriber based, at least in part, on a comparison between the first one or more anonymized values and the second one or more anonymized values.

In particular embodiments, the processor coupled to the at least one memory device are also to compute the second one or more anonymized values via a function identical to a function utilized by the communications device to compute the first one or more anonymized values. In particular embodiments, the function utilized by the communications device to compute the first and second one or more anonymized values corresponds to a one-way function. In particular embodiments, the one-way function corresponds to a hash function. In particular embodiments, the one or more biometric attributes of the subscriber correspond to biometric attributes of the subscriber while the subscriber is in possession of, or co-located with, the communications device. In particular embodiments, the one or more biometric attributes of the subscriber correspond to biometric attributes of the subscriber collected while the subscriber operates the communications device.

Another general aspect includes a method for facilitating authentication of a subscriber of a communications device, including receiving, from an authentication server via a communication services carrier, one or more anonymizing parameters. The method also includes deriving or accessing one or more biometric attributes of the subscriber. The method also includes computing first one or more anonymized values representing the one or more biometric attributes of the subscriber utilizing the one or more anonymizing parameters. The method also includes transmitting signals representative of the first one or more anonymized values to the authentication server via the communication services carrier.

In particular embodiments, the method further includes the communications device receiving signals to indicate authentication of the subscriber based, at least in part, on a comparison between the first one or more anonymized values computed by the communications device and second one or more anonymized values computed at the authentication server. In particular embodiments, the first one or more anonymized values computed by the communications device utilize a function identical to the function utilized to compute the second one or more anonymized values. In particular embodiments, the one or more biometric attributes of the subscriber correspond to attributes collected while the subscriber is in possession of, or at least co-located with, the communications device. In particular embodiments, the one or more biometric attributes of the subscriber correspond to attributes collected while the subscriber operates the communications device. In particular embodiments, computing the first one or more anonymized values corresponds to computing a one-way function that accepts signals representing the one or more biometric attributes of the subscriber and the one or more anonymizing parameters.

Another general aspect includes a communications device having a processor coupled to at least one memory device to receive, from a communication services carrier, one or more parameters to anonymize one or more signal outputs of the communications device. The processor coupled to the at least one memory are additionally to obtain one or more biometric attributes of a subscriber co-located with the communications device. The processor coupled to the at least one memory are additionally to compute first one or more anonymized values to represent the one or more biometric attributes of the subscriber utilizing the one or more parameters to anonymize the one or more signal outputs of the communications device. The processor coupled to the at least one memory are additionally to transmit a signal to indicate the first one or more anonymized values to an authentication server via the communication services carrier.

In particular embodiments, the processor coupled to the at least one memory are additionally to receive a signal to indicate authentication of the communications device based, at least in part, on a comparison between the first one or more anonymized values computed by the communications device and second one or more anonymized values computed at the authentication server. In particular embodiments, the one or more biometric attributes of the subscriber correspond to attributes collected while the subscriber is in possession of, or at least co-located with, the communications device. In particular embodiments, the one or more biometric attributes of the subscriber correspond to attributes collected while the subscriber is operating the communications device. In particular embodiments, the computing of the first one or more anonymized values corresponds to the computing of a one-way function that accepts signals to indicate the one or more biometric attributes of the subscriber and the one or more parameters to anonymize the one or more signal outputs of the communications device.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a telecommunications infrastructure that includes both wireless and wireline communications devices, according to various embodiments.

FIG. 2 shows a subscriber in possession of a communications device to permit interaction with a client server and an authentication server, according to an embodiment.

FIG. 3 is a sample plot showing acceleration as a function of time for a communications device carried by a subscriber, according to an embodiment.

FIGS. 4-5 are sample plots showing acceleration as a function of time for a communications device being operated by a subscriber, according to various embodiments.

FIG. 6 is a diagram showing transfer of biometric attributes from a communications device to an authentication server, according to an embodiment.

FIG. 7 is a flowchart showing operations performed by a communications device, a client server, and an authentication server, according to an embodiment.

FIG. 8 is a flowchart for a method performed by an authentication server to perform authentication utilizing biometric attributes, according to an embodiment.

FIG. 9 is a flowchart for a method performed by a communications device to perform authentication utilizing biometric attributes, according to an embodiment.

FIG. 10 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, in an environment in which electronic communication devices, such as mobile cellular communications devices, voice over Internet protocol (VoIP) communications devices, etc., are increasingly prevalent, a user of an electronic communications device may wish to perform an electronic or digital transaction involving access to secure content. Such transactions may involve completing applications for credit, engaging in electronic financial transactions, purchasing products and/or services, obtaining access to privileged entertainment content, completing loan applications, completing forms involved with applying for healthcare coverage (such as in connection with visiting a health provider's office), and/or engaging in a number of other types of transactions via a communications device. To facilitate these and other types of transactions, a subscriber co-located with a communications device may establish an identity, such as may be established in connection with a communications device subscriber account with a cellular or mobile communications services carrier, a VoIP services provider, or other type of communication services carrier. Establishing an account associated with a communications device, utilizing, for example, a subscriber account identifier (e.g., a cellular telephone number), may permit an individual attempting to engage in an electronic or digital transaction to be authenticated, authorized, and/or verified prior to engaging in the transaction. In some instances, in view of the nature of electronic or digital transactions, such as in an environment in which electronic or digital transactions are initiated via a communications network at any time and at any location, it may be useful to verify and/or authenticate a subscriber relatively quickly, such as in a real-time fashion, for example.

As a general matter, authentication or verification of a subscriber operating, or at least co-located with, a communications device may be desirable in response to a client institution or organization (e.g., a financial institution, a brokerage, a healthcare provider, entertainment content provider, etc.) seeking to determine and/or prove identity of the transacting party. Verification and/or authorization of a subscriber co-located with a communications device may involve establishing a correspondence between the real-world identity of the subscriber and a subscriber account identifier, which may exist in a digital domain. In this context, correspondence, association, and/or similar terms, refers to a persistent, continuing, and objectively verifiable relationship between the subscriber (or other transacting party) in possession of, or co-located with, a particular communications device, such as a mobile communications device. Thus, a unique subscriber account identifier may be employed to signify and/or identify a particular transacting party. In this context, the term “mobile communications device identity” and/or similar terms refer to an identity that leverages a mobile communications device account relationship of a subscriber as a source of authentication and/or verification of a transacting party. Also in this context, the term “mobile subscriber device account” and/or similar terms refer to a mobile communication services provider account. The terms “mobile communications device services provider,” “mobile communications device carrier,” and “mobile network operator” may be used interchangeably. Furthermore, in this context, the term “mobile device services carrier,” “telecommunication services carrier,” “services carrier,” or simply “carrier” may refer to an entity operating within a communications infrastructure to provide wired and/or wireless communication services to the public for a consideration, such as a monthly subscription fee.

In the context of the present disclosure, a “communication services carrier” may refer to a mobile communication services provider and/or mobile network operator. However, there are examples of carriers that do not correspond to mobile communications device services providers and/or mobile network operators. Such instances may include wireline services providers (for example, providers of services operating within the public switched telephone network or PSTN), which include wireline services for rotary-dial telephones and/or telephones utilizing, for example, dual tone multi-frequency (DTMF) signaling. Accordingly, the terms “services carrier” or simply “carrier” may be used in place of a communication services provider and/or wireline telephone services provider without a loss in meaning and/or understanding. In a given situation, particular context of usage should indicate if a term is being used in a general sense or in a narrower sense, such as referring to a mobile communications device services provider, wireline services provider, mobile paging services provider, and/or mobile network operator, for example.

Other aspects of verifying and/or authenticating a mobile subscriber, such as by way of proving that a particular mobile subscriber is in possession of, or at least co-located with, a communications device, are also described in greater detail hereinbelow. For example, in an embodiment, verifying the identity and/or authenticating a subscriber may relate to a mobile subscriber account. Further, a mobile subscriber account is merely an example of a type of subscriber account, especially in a networked electronic commerce environment, although claimed subject matter is not intended to be limited to online accounts or to mobile accounts. Rather, the term “account” or “subscriber account” in this context refers generally to a formal business arrangement between a provider of the account and an entity, a person, or other party seeking to obtain privileges associated with the account. Thus, the term “account” is intended to be broadly interpreted as an arrangement that may provide certain privileges. In this context, privileges may involve access to credit (e.g., so as to facilitate the purchase of goods or services), access to premium entertainment content (e.g., such as premium sports, cinema, or other entertainment content), access to health records, access to financial records, access to financial and/or brokerage accounts, or any other type of access to secure content. In this context, the term “secure content” is intended to be interpreted broadly so as to encompass any type of content available exclusively to certain individuals and/or certain entities in response to supplying certain credentials.

Likewise, an account may comprise various attributes. In this context, the term “subscriber account identifier” refers to a unique descriptor or feature associated with the account that defines certain aspects of the account. For example, in nonlimiting illustrations, a subscriber account identifier may refer to (or may at least be associated with) a mobile telephone number, a mobile subscriber unique alias, an International Mobile Subscriber Identifier (IMSI), Integrated Circuit Card Identifier (ICC ID), a mobile services and/or other type of identifier (e.g., a unique identifier) employed in connection with the particular mobile network operator or the mobile communication services provider. Mobile communications networks may include those compatible or compliant with a Global System for Mobile Communications (GSM) telecommunications network, for example. Other examples of mobile subscriber account identifiers may include an International Mobile Equipment Identifier (IMEI), Mobile Station International Subscriber Directory Number (MSISDN), a mobile equipment identifier or any other identifier that may be utilized to identify a mobile billing account number/identifier.

As discussed herein, a subscriber co-located with, or in possession of, a communications device may apply for an account, such as a credit account, for example, or may apply for any other type of account that imparts or confers particular privileges on the subscriber co-located or in possession of the communications device. In other instances, a subscriber co-located with a mobile device may attempt to engage in a financial transaction, for example, or may attempt to access privileged information/privileged content, just to name a few examples. In many instances, to obtain privilege, such as access to credit, access to privileged information (e.g., streaming premium content or other privileged entertainment content) a mobile subscriber may be required to complete an application, such as an application for an account, an application for credit, an application for an increase in credit, or may be required to make another type of formal request, which involves the subscriber supplying subscriber-specific parameters. However, as previously alluded to, it may be advantageous for the subscriber, and for the institution providing privileges to the subscriber, for example, to verify or prove that, indeed, the subscriber is co-located with (or is in possession of) a particular communications device. By proving possession of a particular communications device, an institution may reduce the risk of an unscrupulous individual, for example, engaging in fraudulent behavior by impersonating a particular mobile subscriber. Such fraudulent behavior may be made possible by an unscrupulous individual stealing another subscriber's mobile phone or identity, or by way of obtaining secure content that permits the unscrupulous individual to impersonate another subscriber.

Thus, in particular embodiments, authenticating a particular subscriber in possession of, or at least co-located with, a communications device may permit and authenticating entity to prove that a specific individual is engaging in a transaction that involves secure content. Obtaining such proof may reduce the likelihood of an unscrupulous individual completing a fraudulent transaction, such as a transaction involving credit applications, increases in credit lines, purchases, asset sales, access to premium entertainment content, or the obtaining of any other type of privileges via fraud and/or deception. In particular embodiments, proving that a particular subscriber is in possession of, or at least co-located with, a communications device may involve a communications device collecting or obtaining biometric attributes of a principal user of the device. In particular embodiments, biometric attributes may be collected, for example, while a subscriber is in possession of, or at least co-located with, the communications device. Biometric attributes may be passively collected, such as without a subscriber's explicit request to do so, such as while the subscriber is walking, running, exercising, and so forth. Such biometric attributes, such as a trace of x-axis, y-axis, and/or z-axis accelerations indicative of a subscriber's typical gait and/or posture assumed while the subscriber is, for example, walking, may be recorded and/or analyzed so as to compute at least a portion of an identity vector used to authenticate a subscriber. In particular embodiments, passively-collected biometric attributes may be obtained while a subscriber is not actively engaged in manipulating controls of a communications device, such as while the communications device is positioned within the subscriber's hip or shirt pocket, backpack, coat, or at another location on the subscriber's person.

In other instances, biometric attributes, such as acceleration traces in the x, y, and/or z-axis, may be passively collected while a subscriber is actively engaged in manipulating one or more controls of a communications device. Active engagement of the communications device may include a subscriber utilizing a texting function of the device, which may involve the subscriber typically orienting the device at a particular angle, or range of angles, relative to a horizontal or vertical plane, for example. While engaging in such an activity, a communications device may undergo, for example, typical accelerations in the x, y, and/or z-axis, perhaps in response to the subscriber's finger or thumb typically depressing or striking locations on a touchscreen of a communications device. In other instances, biometric attributes, such as x, y, and/or z-axis accelerations may be recorded while a subscriber is actively engaged in a telephone call, which may entail the subscriber typically holding the communications device at a particular orientation, such as with respect to the horizontal or vertical plane while communicating.

In particular embodiments, it may be desirable to authenticate a particular subscriber without wireless transmission of biometric attributes. Under certain circumstances, wireless transmission of biometric attributes may permit eavesdropping of an encrypted or unencrypted communications channel. Such eavesdropping may enable an unscrupulous party, for example, to obtain personally identifiable information, or other type of secure content, which may facilitate identity theft and/or may permit the unscrupulous party to impersonate a subscriber. Accordingly, in particular embodiments, an authentication process may bring about the transmission of anonymized signal outputs from a communications device. Thus, in such instances, even though an unscrupulous party, for example, may surreptitiously monitor a communications channel, the absence of personally identifiable information may operate to safeguard against the inadvertent disclosure of such secure content.

In particular embodiments, to bring about transmission of (exclusively) anonymized signal outputs from a communications device during an authentication process, an authentication server may generate and transmit one or more anonymizing parameters for use by the communications device. Responsive to receipt of the one or more anonymizing parameters, the communications device may compute a “one-way” function utilizing various biometric attributes and the one or more anonymizing parameters. In this context, a “one-way” function refers to the use of one or more computing (e.g., mathematical) functions for which computation of a result is relatively easy in comparison with inversion of such function. One example of a one-way function may be a hash function, for example, in which conversion, such as of a vector that includes one or more biometric attributes, into a result represents a relatively straightforward computation. However, inversion of a hash function, which may include performing the computation utilizing a result so as to obtain the original vector representing the one or more biometric attributes, may represent a difficult or even an impossible undertaking. One-way functions other than hash functions are described further herein, and claimed subject matter is not limited to any particular technique or set of techniques involving a use of one way functions.

Accordingly, responsive to computing first one or more anonymized values representing biometric attributes of a subscriber, the first one or more anonymized values may be wirelessly transmitted, for example, from a communications device, through a communications infrastructure, to an authentication server. In particular embodiments, the authentication server may, in turn, perform a similar computation, such as using a one-way function similar or identical to a function utilized by a communications device, so as to generate, second one or more anonymized values representing biometric attributes of a subscriber. The authentication server may then compare first one or more anonymized values obtained from a communications device with second one or more anonymized values computed by the authentication server. In response to detecting agreement (within threshold limits) between the first anonymized values obtained from a communications device with the second anonymized values generated by the authentication server, the authentication server may indicate that the subscriber of the communications device has been authenticated. In response to detecting a disagreement or divergence (e.g., outside of threshold limits) between first anonymized values obtained from a communications device and second anonymized values generated by an authentication server, the authentication server may indicate that the subscriber of the communications device could not be authenticated.

Responsive to an identity verifier having authenticated a subscriber, or otherwise verified that a particular subscriber is, indeed, in possession of (or at least co-located with) a particular communications device, a financial institution, for example, may be confident that a verified and/or authenticated individual is attempting to engage in a transaction. Conversely, in response to an identity verifier determining that a particular subscriber could not be authenticated (e.g., cannot be proven to be in possession of a particular communications device), a financial institution, for example, may elect to deny the purported subscriber from engaging in a financial transaction, for example.

Thus, particular embodiments of claimed subject matter may allow providers of secure content, such as financial institutions, to be assured that an unscrupulous individual, who might attempt to impersonate a particular subscriber, for example, cannot complete a financial transaction. In other instances, a provider of secure content can be assured that an unauthorized user cannot access records, sensitive information, or any other form of secure content. In many instances, precluding unscrupulous individuals from engaging in fraudulent financial transactions, for example, such as by way of the fraudulent impersonation of a particular communications device account holder, operates to protect authentic account holders as well as financial institutions, providers of premium entertainment content, healthcare institutions, and so forth. In addition, following authentication of a particular subscriber, such as by way of determining that the subscriber is (indeed) in possession of a specific communications device, particular embodiments of claimed subject matter may permit an authentication service to report to a financial institution, for example, a measure of trust and/or trustworthiness of a particular communications device. By way of reporting trust and/or trustworthiness of a subscriber to a financial institution, certain types of transactions may be permitted to occur while other types of transactions may be disallowed. Preventing fraudulent transactions may bring about a reduction in instances of identity theft, fraud related to credit cards and/or other instruments, circumventing of parental controls, pirating of exclusive entertainment content, and so forth.

As previously noted, in particular embodiments, after verification of the identity of a particular communication services subscriber, an identity verifier may access a data store to determine a reputation with respect to a communications device. In particular embodiments, a reputation with respect to a communications device may be negatively impacted (e.g., degraded) responsive to the communications device being associated with one or more risk events. Such risk events may include, but are not limited to, recent porting of a subscriber account identifier (e.g., a telephone number) associated with a communications device, recent replacement of a communications device, a recent request of a one-time-password associated with a communications device, removal/replacement of a SIM of a communications device, as well as any number of additional risk events associated with the device. In particular embodiments, a reputation of a communications device may be positively impacted (e.g., enhanced) responsive to the device having never been ported (or having not been ported for a prolonged period of time), having never undergone removal/replacement of a SIM (or having not undergone such removal/replacement of a SIM for a prolonged period of time), and so forth. It should be noted that claimed subject matter is intended to embrace risk events with respect to a communications device other than these, virtually without limitation.

Although the discussion that follows relates to any type of account, in nonlimiting illustrations, accounts corresponding to communications devices may be used for illustration. However, it is understood that claimed subject matter is intended to not be limited to examples provided primarily for purposes of illustration, since such examples may be oversimplified for purposes of comprehension, for example.

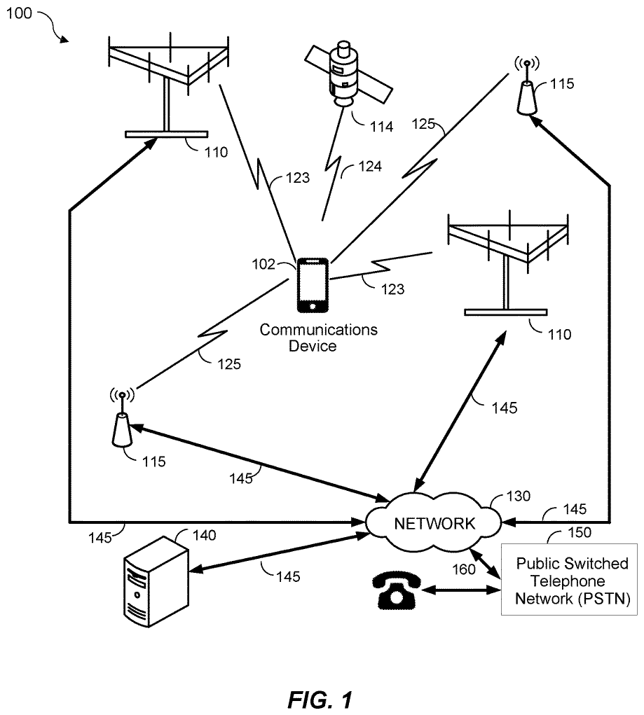

In FIG. 1 (embodiment 100) communications device 102 may transmit radio signals to, and receive radio signals from, a wireless communications network. In an example, communications device 102 may communicate with a cellular communications network by transmitting wireless signals to, and/or receiving wireless signals from, a cellular transceiver 110, which may comprise a wireless base transceiver subsystem, a Node B or an evolved NodeB (eNodeB), over wireless communication link 123. Similarly, communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 110, local transceiver 115, satellite 114, and PSTN 150 represent touchpoints, which permit communications device 102 to interact with network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). In the embodiment of FIG. 1, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, BT and LTE.

In a particular implementation, cellular transceiver 110 and local transceiver 115 may communicate with server 140, such as by way of network 130 via communication links 145. Here, network 130 may comprise any combination of wired or wireless links and may include cellular transceiver 110 and/or local transceiver 115 and/or server 140. In a particular implementation, network 130 may comprise Internet Protocol (IP) or other infrastructure capable of facilitating communication between communications device 102 at a call source and server 140 through local transceiver 115 or cellular transceiver 110. In an embodiment, network 130 may also facilitate communication between communications device 102, server 140 and a PSTN 150, for example through communications link 160. In another implementation, network 130 may comprise a cellular communication network infrastructure such as, for example, a base station controller or packet based or circuit based switching center (not shown) to facilitate mobile cellular communication with communications device 102. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide any such access (if supported) to communications device 102. In some implementations, network 130 may comprise multiple networks (e.g., one or more wireless networks and/or the Internet). In one implementation, network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between communications device 102 and cellular transceiver 110, satellite 114, local transceiver 115, and so forth may occur utilizing signals communicated across wireless communications channels. Accordingly, the term “signal” may refer to communications utilizing propagation of electromagnetic waves across wireless communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in a signal using one or more of the above-identified modulation techniques.

In particular implementations, and as discussed below, communications device 102 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of communications device 102 based on these location related measurements. In some implementations, location related measurements obtained by communications device 102 may be transferred to a location server such as an enhanced serving mobile location center (E-SMLC) or SUPL location platform (SLP) (e.g. which may comprise a server, such as server 140) after which the location server may estimate or determine an estimated location for communications device 102 based on the measurements. In the presently illustrated example, location related measurements obtained by communications device 102 may include measurements of signals 124 received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Communications device 102 or a separate location server may obtain a location estimate for communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at communications device 102. Here, server 140 may be capable of providing positioning assistance data to communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, communications device 102 may obtain measurements of signal strengths for signals received from cellular transceiver 110 and/or local transceiver 115 and/or may obtain a round trip signal propagation time (RTT) between communications device 102 and a cellular transceiver 110 or local transceiver 115. A communications device 102 may use these measurements together with assistance data (e.g. terrestrial almanac data or GNSS satellite data such as GNSS Almanac and/or GNSS Ephemeris information) received from server 140 to determine a location estimate for communications device 102 or may transfer the measurements to server 140 to perform the same determination. A call from communications device 102 may be routed, based on the location of communications device 102, and connected to PSTN 150, for example, via wireless communication link 123 and communications link 160.

A mobile device at a call source (e.g., communications device 102 of FIG. 1) may be referred to by any name corresponding to a cellphone, smartphone, laptop, tablet, PDA, tracking device or some other portable or movable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., communications device 102) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Communications device 102 may also include a sensor suite, which may, for example, include inertial sensors and environment sensors. Inertial sensors of communications device 102 may comprise, for example accelerometers (e.g., collectively responding to acceleration of communications device 102 in and x-direction, a y-direction, and a z-direction). Communications device 102 may further include one or more gyroscopes or one or more magnetometers (e.g., to support one or more compass applications). Environment sensors of communications device 102 may comprise, for example, temperature sensors, barometric pressure sensors, ambient light sensors, camera imagers, microphones, just to name few examples. Sensors of communications device 102 may generate analog or digital signals that may be stored in utilizing one or more memory locations internal to device 102 in support of one or more applications such as, for example, applications collecting or obtaining biometric attributes of a user (e.g., a subscriber) of communications device 102.

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

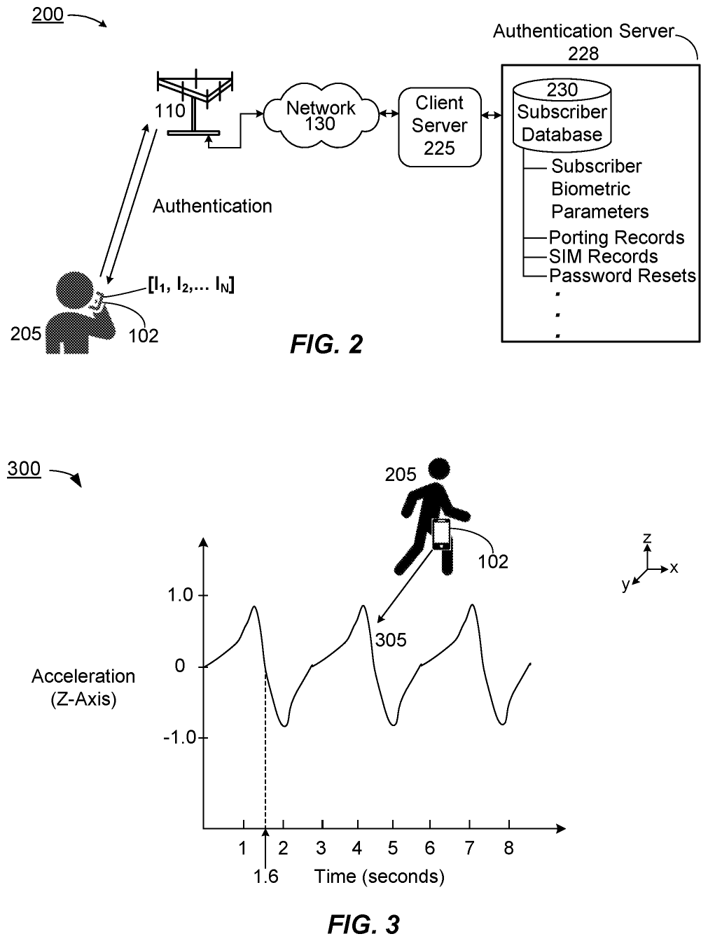

In view of the communications infrastructure shown and described in reference to FIG. 1, more particular embodiments directed toward authenticating a subscriber using biometric attributes are discussed hereinbelow. Thus, FIG. 2 shows a subscriber in possession of a communications device to permit interaction with a client server and an authentication server, according to an embodiment 200. In the embodiment of FIG. 2, mobile subscriber 205 may be located at any point within communications range of cellular transceiver 110. As shown in FIG. 2, communications device 102 may communicate with client server 225 via network 130 utilizing a wireless communications channel between the communications device and cellular transceiver 110. It should be noted, however, that claimed subject matter is not limited exclusively to wireless communications between device 102 and cellular transceiver 110. For example, in particular embodiments, communications device 102 may communicate with client server 225 by way of one or more intervening Wi-Fi networks or by way of wireline telephone services (e.g., the public switched telephone network).

Prior to engaging in a transaction involving client server 225, subscriber 205 may carry, move, and/or transport communications device 102 in accordance with, for example, the everyday activities of subscriber 205. Hence, subscriber 205 may, for example, occasionally place communications device 102 in a briefcase or backpack, for example, while traveling, for example, to a school or to a workplace. In another example, communications device 102 may be occasionally placed in a coat pocket, hip pocket, or at any other location on the person of subscriber 205. Over time, inertial sensors of communications device 102, such as accelerometers that operate to record accelerations in the x, y, and/or z-axis, may assist in developing biometric attributes of subscriber 205. In particular embodiments, as further described in reference to the embodiment of FIG. 3, biometric attributes of subscriber 205 may be passively collected, such as without a subscriber's explicit request to do so, such as while the subscriber is walking, running, exercising, and so forth. Such biometric attributes may be indicative of a typical gait of subscriber 205 and/or the typical posture assumed by the subscriber during such activities. In particular embodiments, passively-collected biometric attributes may be obtained while a subscriber is not actively engaged in manipulating controls of a communications device.

In particular embodiments, biometric attributes may be additionally (passively) collected while a subscriber is engaged in manipulating one or more controls of communications device 102. Active engagement of device 102 may include a subscriber utilizing a texting function of the device, which may involve the subscriber typically orienting device 102 at a particular angle, or within a range of angles, relative to a horizontal (x-axis) or vertical plane (y-axis), for example. While engaging in such an activity, device 102 may undergo, for example, typical accelerations in the x, y, and/or z-axis, perhaps in response to the subscriber's finger or thumb depressing or striking locations on a touchscreen of device 102. In other instances, biometric attributes, such as x, y, and/or z-axis accelerations may be recorded while a subscriber is actively engaged in a telephone call, which may entail the subscriber typically holding the communications device at a particular orientation, such as with respect to the horizontal or vertical plane while communicating. It should be noted that biometric attributes of subscriber 205 may be collected under a variety of additional circumstances, and claimed subject matter is not limited in this respect.

In the embodiment of FIG. 2, communications device 102 may collect, process, and analyze biometric attributes of subscriber 205, so as to arrive at one or more parameters that characterize biometric attributes corresponding to interactions of subscriber 205 with communications device 102. For example, typical accelerations of communications device 102 obtained while subscriber 205 is walking, running, bicycling, or otherwise engaging in an activity aside from operating communications device 102 may be utilized to form an identity vector (shown as [I₁, I₂, . . . I_{N}] in FIG. 2). In particular embodiments, an identity vector may also include subscriber-specific quantities obtained while subscriber 205 is engaging or interacting with communications device 102, such as while texting, browsing, talking, etc. An identity vector may be formed utilizing any number of additional behaviors subscriber behaviors, and claimed subject matter is not limited in this respect.

An identity vector ([I₁, I₂, . . . I_{N}] in FIG. 2) may periodically or occasionally be transmitted to authentication server 228, such as, for example, during a software update of communications device 102. In some instances, a software update may represent a relatively low-risk time-period during which a large number of parameters may be passed between communications device 102 and authentication server 228. Accordingly, an unscrupulous individual attempting to monitor communications between communications device 102 and authentication server 228, may find it difficult or even impossible extract personally identifiable information among a host of unrelated parameters, settings, and other types of information exchanged between device 102 and authentication server 228. In other instances, and identity vector may be passed while communications device 102 is coupled to local transceiver 115 (e.g., a Wi-Fi transceiver), which may indicate that subscriber 205 and device 102 are co-located to a near the subscriber's home Wi-Fi network. An identity vector, or any updates to an identity vector, may be passed between communications device 102 and authentication server 228 under a variety of additional circumstances, and claimed subject matter is not limited in this respect.

Responsive to obtaining an identity vector from communications device 102, authentication server 228 may perform one or more computations, such as utilizing a one-way function, which may transform the identity vector into first one or more anonymized values. Such transformation of the identity vector into the first one or more anonymized values may be performed utilizing operators of a Galois space or by utilizing operators of any other finite-field mathematical space. In particular embodiments, transformation of the identity vector into the first one or more anonymized values may be achieved utilizing a hash function, such as the Secure Hash Algorithm-256 (SHA-256). In particular embodiments, the first one or more anonymized values representing an identity vector are devoid of personally identifiable information, such as specific parameters related to biometric attributes of subscriber 205. Accordingly, at least in some instances, authentication server 228 may be capable of storing parameters relevant to subscriber 205, as well as hundreds, thousands, or even millions of subscribers similar to subscriber 205, but without requiring storage of personally identifiable relevant to any of such subscribers. It should be noted that authentication server 228 may utilize other computational approaches toward anonymizing an identity vector representing biometric attributes of subscribers (e.g., subscriber 205), and claimed subject matter is not limited in this respect.

In accordance with the embodiment of FIG. 2, subscriber 205 may attempt to engage in a financial transaction facilitated by client server 225, which may signify a bank (or other type of financial institution), a healthcare provider, an entertainment content provider, or any other entity that may, at least from time to time, require or obtain authentication of subscriber 205 prior to permitting a transaction to take place. Accordingly, subscriber 205 may initiate a transaction involving client server 225 utilizing a user interface of communications device 102. In the embodiment of FIG. 2, subscriber 205 may establish a browser session, such as a browser session utilizing a mobile Internet service provider, with client server 225. During such a browser session, communications device 102 may transmit, convey, or otherwise signal an intent to engage in a transaction, such as a financial transaction, via client server 225. Alternatively, in particular embodiments, communications device 102 may signal an intent to engage in a transaction outside of a browser-based session, such as by pushing one or more messages (e.g., via short messaging system or SMS messages) to be answered by communications device 102.

Responsive to client server 225 receiving, for example, a transmission signaling an intent of subscriber 205 to initiate a transaction, client server 225 may communicate with authentication server 228. Authentication server 228 may operate to verify, authenticate subscriber 205 currently in possession of, or at least co-located with, communications device 102. As described hereinbelow, authentication server 228 may initiate an authentication process by conveying one or more anonymizing parameters to communications device 102 via client server 225, network 130, and cellular transceiver 110. Following communications device 102 obtaining the one or more anonymizing parameters from authentication server 228, device 102 may access, derive, or otherwise obtain one or more biometric attributes of subscriber 205. In particular embodiments, anonymizing parameters may operate as a cryptographic seed, which operates as an input signal to permit computation of a mathematical transform utilizing a one-way function that accepts signals representing the one or more biometric attributes, such as represented by the identity vector [I₁, I₂, . . . I_{N}]. For example, a one-way function may transform the identity vector into first one or more anonymized values representing biometric attributes of subscriber 205. Such transformation of the identity vector into the first one or more anonymized values may be achieved utilizing operators of a Galois space or utilizing operators of any other finite-field mathematical space. In particular embodiments, transformation of the identity vector into the first one or more anonymized values may be achieved utilizing a hashing function, such as SHA-256. It should be noted that communications device 102 may utilize other computational approaches toward anonymizing an identity vector representing biometric attributes of subscriber 205, and claimed subject matter is not limited in this respect.

Responsive to communications device 102 computing first one or more anonymized values corresponding to biometric attributes of subscriber 205, signals representing the first one or more anonymized values may be transmitted to authentication server 228 via cellular transceiver 110, network 130, and client server 225. Responsive to receipt of the first one or more anonymized values transmitted from communications device 102, authentication server 228 may compare the first one or more anonymized values computed by communications device 102 with second one or more anonymized values computed by authentication server 228. Responsive to obtaining or detecting an agreement (within threshold limits) between first anonymized values, computed by communications device 102, and second anonymized values, computed by authentication server 228, server 228 may determine that subscriber 205 has been authenticated or verified. Accordingly, authentication server 228 may transmit a record of such agreement to client 225. Client 225 may, in turn, permit subscriber 205 to engage in a transaction. Conversely, responsive to detecting a disagreement or divergent (e.g., outside of threshold limits) between first anonymized values, obtained from a communications device, and second anonymized values, generated by authentication server 228, server 228 may determine that subscriber 205 cannot be authenticated or verified. Accordingly, authentication server 228 may transmit a record of such disagreement or divergence to client 225. Client 225 may, in turn, terminate or disallow subscriber 205 from engaging in the transaction. Results of comparisons between first and second one or more anonymized values may bring about additional actions by server 228, and claimed subject matter is not limited in this respect.

In particular embodiments, authentication server 228 may utilize parameters, such as a subscriber account identifier (e.g., a mobile telephone number) and/or other parameters obtained from communications device 102, to access one or more records relating to historical events relevant to device 102. Accordingly, authentication server 228 may access device database 230 to obtain account information comprising the name, address, phone number, and other parameters of subscriber 205. Authentication server 228 may additionally obtain historical records of deterministic events with respect to communications device 102. In some embodiments, authentication server 228 may access device database 230, so as to permit computing of a trustworthiness score or other measure of trustworthiness, with respect to communications device 102. A trustworthiness score or trustworthiness measure may be based, at least in part, on historical records relating to instances of reassignment or porting of subscriber account identifiers (e.g., a telephone number) from a first communication services carrier to a second communication services carrier. A trustworthiness score or trustworthiness measure may be based, at least in part, on tenure of communications device 102, which may relate to a period of time subscriber 205 has owned, leased, or utilized services of a carrier to provide communication services to device 102. A trustworthiness score or trustworthiness measure may be based, at least in part, on whether device 102 has undergone a SIM removal/replacement. In particular embodiments, responsive to determining whether such historical events have occurred and, perhaps, a frequency of occurrence of one or more historical events, authentication server 228 may provide client server 225 with a trustworthiness score or trustworthiness measure. In particular embodiments, a trustworthiness score or trustworthiness measure, in addition to results of comparisons between first anonymized values, computed by communications device 102, and second anonymized values, computed by authentication server 228, may, in combination, provide a basis for client 225 to approve (or perhaps to disapprove) a transaction. It should be noted that claimed subject matter is intended to embrace additional contributors to a trustworthiness score or trustworthiness measure of communications device 102 and/or subscriber 205, virtually without limitation.

FIG. 3 is a sample plot showing acceleration as a function of time for a communications device carried by a subscriber, according to embodiment 300. In the embodiment of FIG. 3, a subscriber, such as subscriber 205 of FIG. 2 may be in possession of, or be co-located with, a communications device, such as communications device 102. As shown in FIG. 3, at a time other than a time during which subscriber 205 is operating communications device 102 (e.g., prior to subscriber 205 initiating a financial transaction utilizing device 102), subscriber 205 may engage in everyday activities. While engaging in such everyday activities, subscriber 205 may carry communications device 102 on his or her person. For example, as shown in FIG. 2, subscriber 205 may position communications device 102 in a hip pocket while subscriber 205 walks, runs, or performs other everyday activities. It should be noted that subscriber 205 may position device 102 at any other location on, or proximate with, the subscriber's person, and claimed subject matter is not limited in this respect.

In the embodiment of FIG. 3, inertial sensors of communications device 102, such as accelerometers operating in one or more of the x-direction, the y-direction, and the z-direction, may provide output signals corresponding to signal trace 305. Although output signal trace 305 corresponds to acceleration in the z-axis, inertial sensors of a communications device may provide additional traces with respect to the y-axis and/or the x-axis. As indicated in FIG. 3, subscriber 205 walks with a gait having a dominant frequency of approximately one event within a gait period of about 1.6 seconds. Accordingly, subscriber 205 may be characterized as having a gait frequency of approximately 0.625 Hz (1/1.6 sec). Additionally, the gait of subscriber 205 comprises a relative acceleration amplitude of approximately 0.90 (units arbitrary), also in the z-axis. It should be noted that the gait of subscriber 205 may include a gait periods and amplitudes with respect to additional axes, and claimed subject matter is not limited in this respect.

It may be appreciated that output signal trace 305 may be unique to subscriber 205 and may be dependent upon numerous physical traits and characteristics of subscriber 205. For example, a relatively tall subscriber may exhibit a gait having a dominant frequency that is lower than a gait frequency exhibited by an average-sized subscriber, or by a subscriber having a relatively small stature. Further, an older or perhaps infirmed subscriber, for example, may exhibit a gait having an even lower dominant frequency. Conversely, a younger subscriber, or perhaps a subscriber having a relatively small stature, may exhibit a gait having a dominant frequency that is higher than the gait of an average-sized subscriber.

In particular embodiments, over a duration, which may comprise a few days, a few weeks, a few months, a few years, and so forth, a computer processor may record and/or process output signals from inertial sensors within communications device 102. Such recording may occur without advance notification to the subscriber, so as to operate as a background process performed by communications device 102. Responsive to such recording and/or processing of sensor output signals, the computer processor may generate or derive biometric attributes of subscriber 205. Such biometric attributes may relate to a dominant gait frequency, a dominant gait amplitude, a dominant gait velocity (e.g., a speed), and any other attributes typical to subscriber 205. Further, over a duration, such as a duration of a few days, a few weeks, a few months, etc., a computer processor of device 102 may occasionally or periodically refine such biometric attributes.

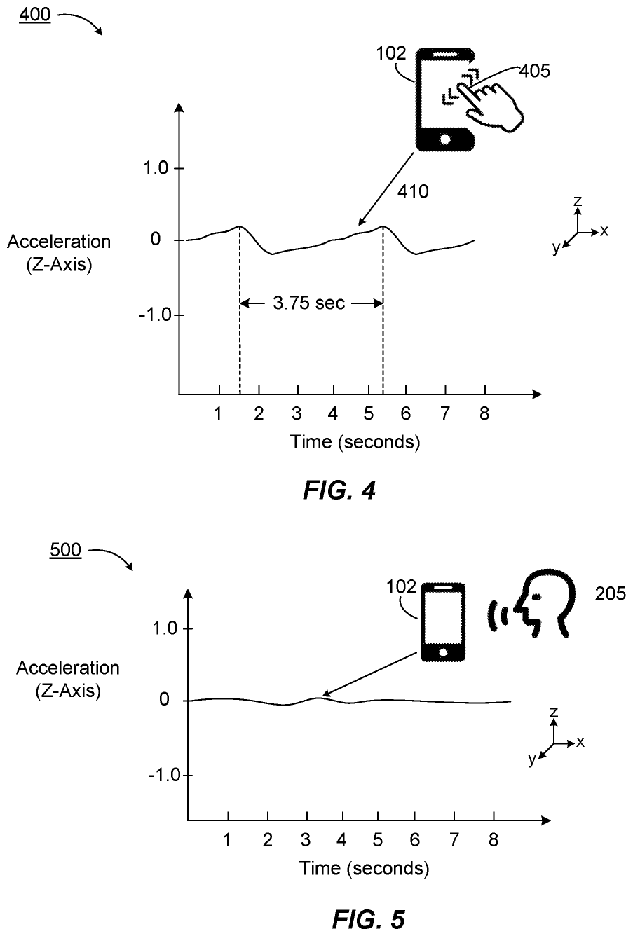

FIG. 4 is a sample plot showing acceleration as a function of time for a communications device being operated by a subscriber, according to embodiment 400. In contrast to the embodiment of FIG. 3, which refers to sensor output signals collected via a background process performed while a subscriber transports or carries communications device 102, the embodiment of FIG. 4 refers to collection of sensor output signals while a subscriber actively engages or operates device 102. Thus, for example, while a subscriber sweeps his or her finger 405 across a display of communications device 102, or performs another manipulation of communications device 102, inertial sensors of device 102 may generate output signal trace 410. As indicated in FIG. 4, sensor output signal trace 410 may comprise a dominant frequency, such as corresponding to acceleration in the z-axis, of approximately 0.267 Hz (1/3.75 sec). Additionally, subscriber 205 interacting with a touchscreen, for example, of communications device 102 may bring about accelerations having an amplitude of (e.g., vibrations) having an amplitude of 0.1 (units arbitrary). It should be noted that subscriber 205 interacting with device 102 may bring about accelerations in other axes (e.g., x-axis, y-axis), and claimed subject matter is intended to embrace accelerations in these axes as well.

Accordingly, at least in particular embodiments, acceleration trace 410 may be unique to subscriber 205 and may be dependent upon numerous physical traits and characteristics of subscriber 205. For example, a subscriber who typically holds a communications device upright while texting may bring about accelerations having a particular frequency and amplitude. In contrast, a subscriber who typically places a communications device on a surface while texting may give rise to different vibrational frequencies of communications device 102, or similar vibrational frequencies having reduced amplitudes. Further, a subscriber who typically enters alphanumeric characters at a rate slower than average may bring about accelerations having relatively low frequency. Conversely, a subscriber who typically enters alphanumeric characters at a rate greater than an average rate may bring about accelerations having relatively higher frequencies.

Consequently, in particular embodiments, over a duration, which may comprise a few days, a few weeks, a few months, a few years, and so forth, a computer processor of communications device 102 may record and/or process output signals from inertial sensors within the device. Such recording may occur without advance notification to the subscriber, so as to operate as a background process performed by communications device 102. Responsive to such recording and/or processing of sensor output signals, the computer processor may generate biometric attributes of subscriber 205. Such biometric attributes may relate to frequencies and amplitudes of accelerations that accompany interactions with a communications device. Further, over a duration, such as a duration of a few days, a few weeks, a few months, etc., a computer processor of device 102 may occasionally or periodically refine such biometric attributes.

FIG. 5 is a sample plot showing acceleration as a function of time for a communications device being operated by a subscriber, according to embodiment 500. In the embodiment of FIG. 5, subscriber 205 shown as speaking into a microphone, for example, of communications device 102. Such interaction may occur during a telephone call initiated or received by subscriber 205. In a manner similar to that of FIG. 4, during such interactions, a communications device may generate and refine one or more biometric attributes representative of subscriber 205 while the subscriber actively engages with device 102.

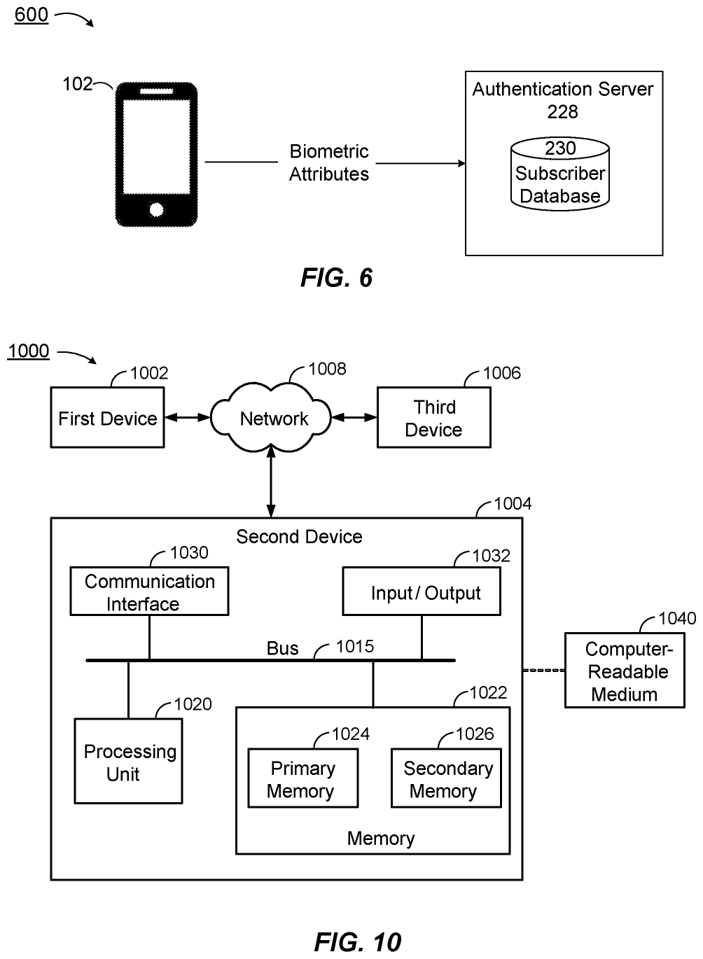

FIG. 6 is a diagram showing a transfer of biometric attributes from a communications device to an authentication server, according to an embodiment 600. In the embodiment of FIG. 6, perhaps during a software update of communications device 102, the device may transfer, upload, or otherwise convey biometric attributes, such as an identity vector [I₁, I₂, . . . I_{N}]. Although not shown explicitly in FIG. 6, communications device 102 may transmit biometric attributes to subscriber database 230 of authentication server 228 utilizing a communications infrastructure such as described in reference to FIG. 1. As noted previously herein, transmitting biometric attributes may occur during, for example, a software update to communications device 102 and/or may occur while device 102 is wirelessly coupled to the subscriber's home wireless (e.g., Wi-Fi) access point, such as local transceiver 115. In particular embodiments, responsive to transmission of biometric attributes, such as an identity vector, communications device 102 and authentication server 228 may store identical parameters of, for example, subscriber 205. Accordingly, in particular embodiments, a mathematical operation, such as a one-way function, computed at communications device 102 versus authentication server 228 would yield identical or near-identical results. For example, responsive to a processor of communications device 102 computing a hashing function utilizing input signals representative of an I vector comprising biometric attributes of subscriber 205 would yield results identical to results of authentication server 228 computing the hashing function using the identical I vector. In such instances, as previously noted herein, authentication of subscriber 205 may be accomplished via communications device 102 and authentication server 228 processing the same one-way function and comparing outcomes of such processing. It should be noted that outcomes of such processing may be devoid of any personally identifiable information of subscriber 205.

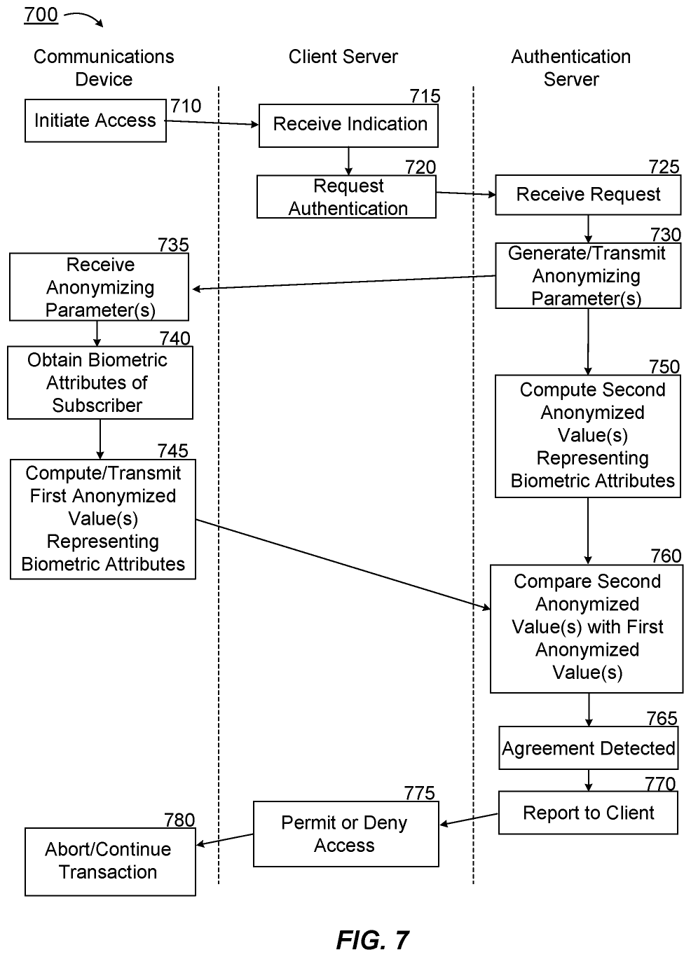

FIG. 7 is a flowchart for a method performed by a communications device, a client server, and an authentication server, according to an embodiment 700. In the embodiment of FIG. 7, the communications device, the client server, and the authentication server, may refer to communications device 102, client server 225, and authentication server 228, although claimed subject matter is not limited in this respect. Rather, the communications device and servers of FIG. 7 may refer to numerous other processing entities of an authenticating system. It should be noted that the disclosed embodiments, such as the embodiment of FIGS. 7, 8, and 9 are intended to embrace numerous variations, including methods that may include actions in addition to those depicted in the figures, actions performed in an order different than those depicted in the figures, as well as methods including fewer steps than those depicted.

The method of FIG. 7 may begin at 710, in which a subscriber, such as subscriber 205 of FIG. 2, initiates contact with an institution, such as a financial services provider, entertainment content provider, etc., to obtain access to sensitive information or other form of secure content. At 715, a client server, which may operate under the control and/or direction of an institution (e.g., a financial institution) may generate a request to authenticate subscriber 205 who may be operating, or may at least be co-located with, a particular communications device. Responsive to receiving a request, such as at 725, to authenticate a subscriber, the authentication server may generate and/or transmit anonymizing parameters for transmission to the communications device. At 735, the communications device may receive the one or more anonymizing parameters and, at 740, may access, obtain, and/or derive biometric attributes of the subscriber. At 745, the communications device may compute first one or more anonymized values representing biometric attributes. In particular embodiments, 745 may involve a processor coupled to at least one memory device of the communications device computing, such as via a one-way function, that utilizes signals representing biometric attributes of the subscriber. Also at 745, the communications device may transmit the first one or more anonymized values to the authentication server.

In the embodiment of FIG. 7, following transmission of anonymized parameters to the communications device, such as at 730, the authentication server may compute, such as at 750, second one or more anonymized values representing biometric attributes of subscriber 205. Computation at 750 may involve use of the identical one-way function utilized by the communications device to compute (such as at 745) the first one or more anonymized values representing biometric attributes of the subscriber. At 760 the second one or more anonymized values computed by the communications device (e.g., at 745) may be compared with the second one or more anonymized values computed by the authentication server (e.g., at 750). At 765, if the authentication server detects agreement (or disagreement) between results computed by the authentication server and results computed by the communications device, such agreement or disagreement may be reported to the client server, such as at 770. At 775, responsive to receiving an indication of agreement or disagreement between computed first and second anonymized values, the client server may permit or deny the transaction initiated at 710. At 780, the subscriber may abort or continue the transaction based, at least in part, on signals received from the client server generated at 775.

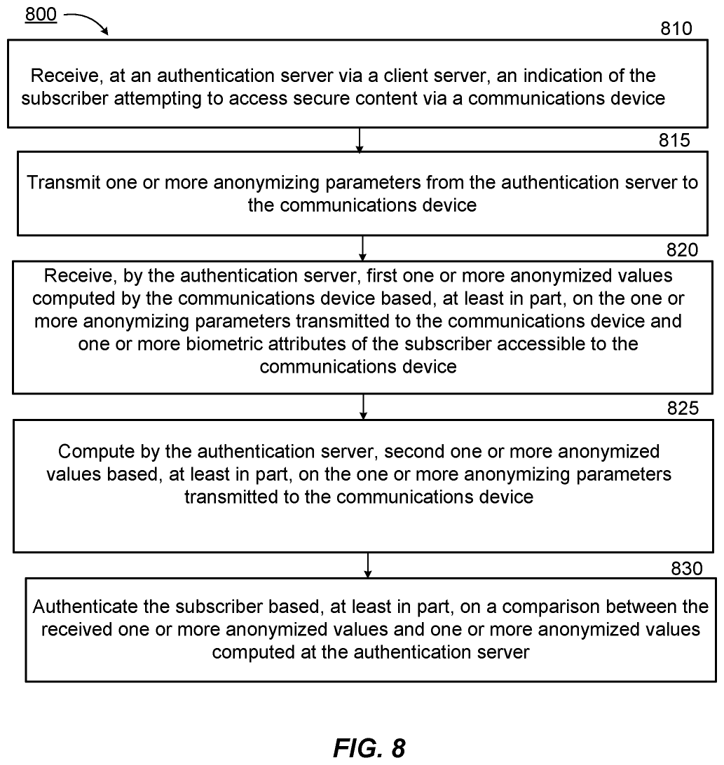

FIG. 8 is a flowchart for a method performed by an authentication server to perform authentication utilizing biometric attributes, according to an embodiment. The method of FIG. 8, which may correspond to a method performed at an authentication server, may begin at 810, in which the authentication server may receive an indication that a subscriber (e.g., subscriber 205 of FIG. 2) is attempting to access secure content via the communications device. At 815, the authentication server may transmit one or more anonymizing parameters from the server to the communications device. At 820, the authentication server may receive, perhaps in response to transmitting the one or more anonymizing parameters to the communications device, one or more first anonymized values computed utilizing the one or more anonymizing parameters and one or more biometric attributes of the subscriber. The first one or more anonymized values may be computed utilizing a one-way function in which, for example, computation in a first direction may represent a relatively straightforward operation, while computation in the reverse direction (e.g., inversion) may represent a difficult or impossible operation.

At 825, the authentication server may compute second one or more anonymized values based, at least in part, on the one or more anonymizing parameters transmitted to the communications device, such as at 820. At 830, the authentication server may authenticate the subscriber based, at least in part, on a comparison between the received first one or more anonymized values, computed by the communications device, and a second one or more anonymized values, computed at the authentication server.

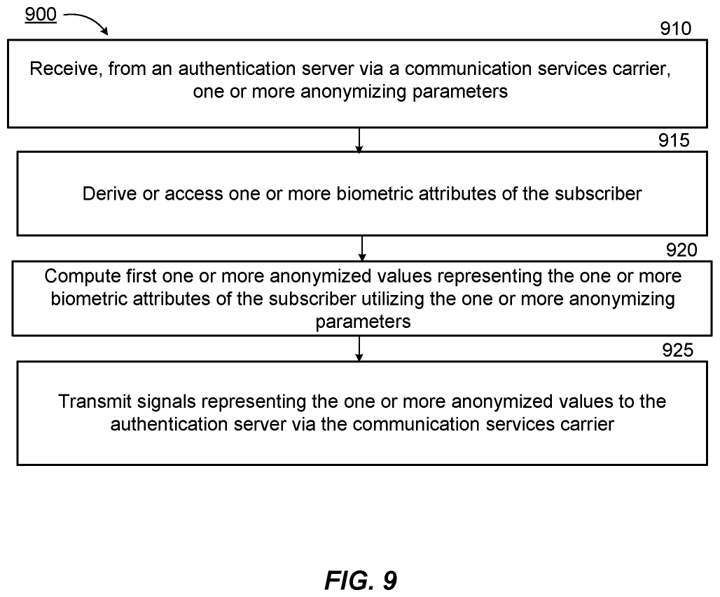

FIG. 9 is a flowchart for a method performed by a communications device to perform authentication utilizing biometric attributes, according to an embodiment. The method of FIG. 9 may begin at 910, in which the communications device may receive, such as from an authentication server utilizing a communication services carrier, one or more anonymizing parameters. At 915, the communications device may derive or access one or more biometric attributes of the subscriber. At 920, the communications device may compute one or more anonymized values representing the one or more biometric attributes of the subscriber utilizing the one or more anonymizing parameters. 925 may include transmitting signals representing the one or more anonymized values to the authentication server via the communication services carrier.

FIG. 10 is a diagram showing a computing environment, according to an embodiment 1000. In the embodiment of FIG. 10, first and third devices 1002 and 1006 may be capable of rendering a graphical user interface (GUI) for a network device, such as server device 140 of FIG. 1, so that a subscriber utilizing a communications device (e.g., a mobile communications device) may engage in system use. Device 1004 may potentially serve a similar function in this illustration. Likewise, in FIG. 10, computing device 1002 (‘first device’ in FIG. 10) may interface with computing device 1004 (‘second device’ in FIG. 10), which may, for example, also comprise features of a client computing device and/or a server computing device, in an embodiment that implements a client/server computing model. Processor (e.g., processing device) 1020 and memory 1022, which may comprise primary memory 1024 and secondary memory 1026, may communicate by way of a communication interface 630, for example. The term “computing device,” in the context of the present patent application, refers to a system and/or a device, such as a computing apparatus, that includes a capability to process (e.g., perform computations) and/or store electronic digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1004, as depicted in FIG. 10, is merely one example, and claimed subject matter is not limited in scope to this particular example.

In FIG. 10, computing device 1002 may provide one or more sources of executable computer instructions in the form of physical states and/or signals (e.g., stored in memory states), for example. Computing device 1002 may communicate with computing device 1004 by way of a network connection, such as via network 1008, for example. As previously mentioned, a connection, while physical, may be virtual while not necessarily being tangible. Although computing device 1004 of FIG. 10 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1022 may comprise any non-transitory storage mechanism. Memory 1022 may comprise, for example, primary memory 1024 and secondary memory 1026, additional memory circuits, mechanisms, or combinations thereof may be used. Memory 1022 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1022 may comprise one or more articles utilized to store a program of executable computer instructions. For example, processor 1020 may fetch executable instructions from memory and proceed to execute the fetched instructions. Memory 1022 may also comprise a memory controller for accessing device readable-medium 1040 that may carry and/or make accessible digital content, which may include code, and/or instructions, for example, executable by processor 1020 and/or some other device, such as a controller, as one example, capable of executing computer instructions, for example. Under direction of processor 1020, a non-transitory memory, such as memory cells storing physical states (e.g., memory states), comprising, for example, a program of executable computer instructions, may be executed by processor 1020 and able to generate signals to be communicated via a network, for example, as previously described. Generated signals may also be stored in memory, also previously suggested.

Memory 1022 may store electronic files and/or electronic documents, such as relating to one or more users, and may also comprise a machine-readable medium that may carry and/or make accessible content, including code and/or instructions, for example, executable by processor 1020 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 1020 may comprise one or more circuits, such as digital circuits, to perform at least a portion of a computing procedure and/or process. By way of example, but not limitation, processor 1020 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 1020 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 10 also illustrates device 1004 as including a component 1032 operable with input/output devices, and communication bus 1015, for example, so that signals and/or states may be appropriately communicated between devices, such as device 1004 and an input device and/or device 1004 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more communications devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a client server device and/or a communications device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a communications device and/or a client server device in various embodiments. Network devices capable of operating as a client server, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a communications device, as well as other types of devices, including between wired and/or wireless devices coupled via a wired and/or wireless network, for example, or any combination thereof. It is noted that the terms, server, server device, server computing device, server computing platform and/or similar terms are used interchangeably.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a subscriber, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a communications device application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method of authenticating a subscriber co-located with a communications device, comprising:
receiving, at an authentication server via a client server, an indication of the subscriber attempting to access secure content via the communications device;
transmitting one or more anonymizing parameters from the authentication server to the communications device;
receiving, by the authentication server, first one or more anonymized values computed by the communications device based, at least in part, on the one or more anonymizing parameters transmitted to the communications device and one or more biometric attributes of the subscriber accessible to the communications device;
computing, by the authentication server, second one or more anonymized values based, at least in part, on the one or more anonymizing parameters transmitted to the communications device; and
authenticating the subscriber based, at least in part, on a comparison between the first one or more anonymized values and the second one or more anonymized values.

2. The method of claim 1, further comprising the authentication server obtaining the one or more anonymizing parameters and one or more biometric attributes of the subscriber prior to authenticating the subscriber.

3. The method of claim 2, further comprising permitting the subscriber to access the secure content responsive to authenticating the subscriber.

4. The method of claim 1, wherein the first and second one or more anonymized values are computed utilizing a one-way function that accepts signals representing the one or more biometric attributes of the subscriber and the one or more anonymizing parameters.

5. The method of claim 4, wherein the one-way function corresponds to a hash function.

6. The method of claim 1, wherein the attempt to access the secure content corresponds to a login attempt by the subscriber via the communications device.

7. The method of claim 1, wherein the communications device corresponds to a mobile communications device.

8. The method of claim 1, wherein the one or more biometric attributes of the subscriber correspond to attributes collected while the subscriber is in possession of, or at least co-located with, the communications device.

9. The method of claim 8, wherein the one or more biometric attributes of the subscriber correspond to biometric attributes of the subscriber collected while the subscriber is operating the communications device.

10. The method of claim 1, wherein the one or more biometric attributes of the subscriber correspond to passively-collected attributes.

11. An apparatus comprising:
a processor coupled to at least one memory device to:
receive an indication in response to a subscriber attempting to access secure content via a communications device;
transmit one or more parameters to anonymize one or more signal outputs of the communications device;
receive first one or more anonymized values computed by the communications device based, at least in part, on the one or more anonymizing parameters transmitted to the communications device and one or more biometric attributes of the subscriber accessible to the communications device;
compute second one or more anonymized values based, at least in part, on the one or more anonymizing parameters transmitted to the communications device; and
authenticate the subscriber based, at least in part, on a comparison between the first one or more anonymized values and the second one or more anonymized values.

12. The apparatus of claim 11, wherein the processor coupled to the at least one memory device to authenticate the subscriber is to:
compute the second one or more anonymized values via a function identical to a function utilized by the communications device to compute the first one or more anonymized values.

13. The apparatus of claim 12, wherein the function utilized by the communications device to compute the first and second one or more anonymized values corresponds to a one-way function.

14. The apparatus of claim 13, wherein the one-way function corresponds to a hash function.

15. The apparatus of claim 11, wherein the one or more biometric attributes of the subscriber correspond to biometric attributes of the subscriber while the subscriber is in possession of, or co-located with, the communications device.

16. The apparatus of claim 15, wherein the one or more biometric attributes of the subscriber correspond to biometric attributes of the subscriber collected while the subscriber operates the communications device.

17. A method for facilitating authentication of a subscriber of a communications device, comprising:
receiving, from an authentication server via a communication services carrier, one or more anonymizing parameters;
deriving or accessing one or more biometric attributes of the subscriber;
computing first one or more anonymized values representing the one or more biometric attributes of the subscriber utilizing the one or more anonymizing parameters; and
transmitting first signals representative of the first one or more anonymized values to the authentication server via the communication services carrier.

18. The method of claim 17, further comprising the communications device receiving second signals to indicate authentication of the subscriber based, at least in part, on a comparison between the first one or more anonymized values computed by the communications device and second one or more anonymized values computed at the authentication server.

19. The method of claim 18, wherein the first one or more anonymized values computed by the communications device utilize a function identical to the function utilized to compute the second one or more anonymized values.

20. The method of claim 17, wherein the one or more biometric attributes of the subscriber correspond to attributes collected while the subscriber is in possession of, or at least co-located with, the communications device.

21. The method of claim 20, wherein the one or more biometric attributes of the subscriber correspond to attributes collected while the subscriber operates the communications device.

22. The method of claim 17, wherein computing the first one or more anonymized values corresponds to computing a one-way function that accepts third signals representing the one or more biometric attributes of the subscriber and the one or more anonymizing parameters.

23. A communications device, comprising:
a processor coupled to at least one memory device to:
receive, from a communication services carrier, one or more parameters to anonymize one or more signal outputs of the communications device;
obtain one or more biometric attributes of a subscriber co-located with the communications device;
compute first one or more anonymized values to represent the one or more biometric attributes of the subscriber utilizing the one or more parameters to anonymize the one or more signal outputs of the communications device; and
transmit a first signal to indicate the first one or more anonymized values to an authentication server via the communication services carrier.

24. The communications device of claim 23, wherein the processor coupled to the at least one memory is additionally to:
receive a second signal to indicate authentication of the communications device based, at least in part, on a comparison between the first one or more anonymized values computed by the communications device and second one or more anonymized values computed at the authentication server.

25. The communications device of claim 23, wherein the one or more biometric attributes of the subscriber correspond to attributes collected while the subscriber is in possession of, or at least co-located with, the communications device.

26. The communications device of claim 25, wherein the one or more biometric attributes of the subscriber correspond to attributes collected while the subscriber is operating the communications device.

27. The communications device of claim 23, wherein computing of the first one or more anonymized values corresponds to the computing of a one-way function that accepts a third signal to indicate the one or more biometric attributes of the subscriber and the one or more parameters to anonymize the one or more signal outputs of the communications device.
